(19) United States
(12) Patent Application Publication
(10) Pub. No.: US 2023/0182661 A1
(43) Pub. Date: Jun. 15, 2023

(54) BUS BAR STRUCTURE AND METHOD OF USING THE SAME

(71) Applicant: TOYOTA JIDOSHA KABUSHIKI KAISHA, Toyota-shi (JP)

(72) Inventors: Shota DOI, Toyota-shi (JP); Kenjiro SHIBA, Takahama-shi (JP); Yoshihiro MORITA, Okazaki-shi (JP)

(73) Assignee: TOYOTA JIDOSHA KABUSHIKI KAISHA, Toyota-shi (JP)

(21) Appl. No.: 17/960,921

(22) Filed: Oct. 6, 2022

(30) Foreign Application Priority Data
Dec. 15, 2021 (JP) 2021-203323

(51) Int. Cl. B60R 16/03; H02G 5/06

(52) U.S. Cl. CPC B60R 16/03; H02G 5/06

(57) ABSTRACT

A bus bar structure includes a bus bar disposed to extend along an outer surface of a housing of an electrical device; and a non-conductive lower cover provided to extend along the bus bar to cover a first surface of the bus bar, the first surface facing the outer surface. The lower cover includes a first hole portion that allows insertion of a fixing member configured to fix the lower cover at a first position on the outer surface, the first hole portion having a major axis extending along a first direction of the housing. The bus bar includes a second hole portion that allows insertion of a connection member configured to electrically connect the bus bar to a terminal at a second position on the outer surface, the second hole portion having a major axis extending along a second direction that intersects the first direction.

### CROSS-REFERENCE TO RELATED APPLICATION

This application claims priority to Japanese Patent Application No. 2021-203323 filed on Dec. 15, 2021, incorporated herein by reference in its entirety.

### BACKGROUND

### 1. Technical Field

The technology disclosed herein relates to a bus bar structure that allows a flat elongated bus bar to be disposed to extend along the outer surface of a housing of an electrical device, and to a method of using the same.

### 2. Description of Related Art

Japanese Unexamined Patent Application Publication No. 2021-97089 (JP 2021-97089 A) discloses a structure that allows a bus bar to be disposed to extend along the outer surface of a housing of an electrical device or the like. The bus bar is a flat elongated metal plate for energizing components, and is a conductor that is suitable to transmit high electric power. When the bus bar is disposed on the outer surface of a housing, it is necessary to provide a flexible lower cover made from resin or the like for insulation between the housing and the bus bar, for example.

### SUMMARY

The position etc. of the terminal on the housing differ among electrical devices. For example, it is occasionally necessary to change the shape of the bus bar in accordance with the position etc. of the terminal on the housing. Further, it is occasionally necessary to change the shape of the lower cover in accordance with a change in a point of attachment of the lower cover to the housing.

The disclosure provides a bus bar structure that is highly adaptable to changes in points of attachment of a bus bar and a lower cover to a housing, and a method of using the same.

A first aspect of the disclosure relates to a bus bar structure. A bus bar structure includes a bus bar disposed to extend along an outer surface of a housing of an electrical device; and a non-conductive lower cover provided to extend along the bus bar to cover a first surface of the bus bar, the first surface facing the outer surface of the housing. The lower cover includes a first hole portion that allows insertion of a fixing member configured to fix the lower cover at a first position on the outer surface of the housing, the first hole portion having a major axis extending along a first direction of the housing. The bus bar includes a second hole portion that allows insertion of a connection member configured to electrically connect the bus bar to a terminal at a second position on the outer surface of the housing, the second hole portion having a major axis extending along a second direction that intersects the first direction.

With the bus bar structure according to the first aspect of the disclosure, even if the first position and the second position on the outer surface of the housing, at which the lower cover and the bus bar are attached, are varied, the lower cover and the bus bar can be attached with such variations allowed by the first hole portion and the second hole portion that are long holes having respective major axes extending in directions intersecting each other. Therefore, the bus bar structure can be adapted to changes in the attachment positions without requiring changes in the shapes of the lower cover and the bus bar. Consequently, it is possible to attach the bus bar structure to the outer surface of the housing for electrical devices of different kinds.

A second aspect of the disclosure relates to a method of using a bus bar structure for a housing of an electrical device. This method includes preparing the bus bar structure according to the first aspect of the disclosure. The method also includes attaching the lower cover of the bus bar structure to the outer surface of the housing using the first hole portion and the fixing member, and then connecting the bus bar of the bus bar structure to the terminal using the second hole portion and the connection member.

With this method according to the second aspect of the disclosure, the lower cover can be attached to the housing and the bus bar can be connected to the terminal at the first hole portion and the second hole portion, respectively, of the bus bar structure even if the points of attachment of the lower cover and the bus bar on the housing are different depending on the kind of the electrical device. Attaching the lower cover and then connecting the bus bar allows the bus bar to be connected to the terminal easily, and allows the bus bar to be attached to the housing efficiently.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded view of a bus bar structure;

FIG. 2 illustrates the bus bar structure, which has been assembled, in the state of being disposed on a side surface of a housing;

FIG. 3A illustrates an attachment hole portion that is a long hole and the vicinity thereof in a lower cover, and FIG. 3B illustrates a hole portion that is a long hole and the vicinity thereof in a bus bar; and

FIG. 4 is an exploded view illustrating the state of attachment of the bus bar structure to a side surface of a housing of a power control unit.

### DETAILED DESCRIPTION OF EMBODIMENTS

In the above bus bar structure according to an embodiment of the technology disclosed herein, the housing may have a three-dimensional shape with a height, a depth, and a width; the first direction may be one of an up-down direction extending along the height of the housing, a front-rear direction extending along the depth of the housing, and a right-left direction extending along the width of the housing; and the second direction may be a direction that is orthogonal to the first direction. By setting the first direction and the second direction such that the first and second directions are orthogonal to each other in this manner, it is possible to efficiently absorb changes in the positions of attachment of the bus bar and the lower cover using the first hole portion and the second hole portion. In this embodiment, the outer surface of the housing may be a side surface of the housing; the first direction may be one of the right-left direction and the front-rear direction of the housing; and the second direction may be a direction that is orthogonal to the first direction. With this configuration, it is possible to effectively absorb variations in the points of attachment of the bus bar and the lower cover on the side surface of the housing. In this embodiment, further, the lower cover may include the first hole portion provided at a middle portion of the lower cover in a direction of extension of the lower cover; the first hole portion may be configured such that an outer peripheral surface of the fixing member contacts inside surfaces defining the first hole portion, the inside surfaces defining the first hole portion facing each other in a minor-axis direction of the first hole portion; the bus bar may include the second hole portion provided at one end portion of the bus bar in a direction of extension of the bus bar; and the second hole portion may be configured such that an outer peripheral surface of the connection member contacts inside surfaces defining the second hole portion, the inside surfaces defining the second hole portion facing each other in a minor-axis direction of the second hole portion. With this configuration, it is possible to precisely attach the bus bar structure to the side surface of the housing.

In the above bus bar structure according to an embodiment of the technology disclosed herein, the first hole portion may be configured such that an outer peripheral surface of the fixing member contacts inside surfaces defining the first hole portion, the inside surfaces defining the first hole portion facing each other in a minor-axis direction of the first hole portion; and the second hole portion may be configured such that an outer peripheral surface of the connection member contacts inside surfaces defining the second hole portion, the inside surfaces defining the second hole portion facing each other in a minor-axis direction of the second hole portion. With this configuration, it is possible to position the lower cover and the bus bar using the first hole portion and the second hole portion, and thus, it is possible to secure the precision in attaching the bus bar structure.

In the above bus bar structure according to an embodiment of the technology disclosed herein, the first hole portion may be provided at a middle portion of the lower cover in a direction of extension of the lower cover, and the second hole portion may be provided at one end portion of the bus bar in a direction of extension of the bus bar. With this configuration, it is possible to improve the working efficiency in attaching the lower cover.

In the above bus bar structure according to an embodiment of the technology disclosed herein, the bus bar may include inclined portions inclined from one end portion and another end portion of the bus bar in a direction of extension of the bus bar toward a middle portion of the bus bar between the one end portion and the other end portion such that the middle portion is spaced from the outer surface of the housing. With this configuration, it is possible to reduce a shearing load due to a difference in linear expansion due to temperature variations.

In the above bus bar structure according to an embodiment of the technology disclosed herein, the bus bar may include the second hole portion provided at one end portion of the bus bar in a direction of extension of the bus bar, and a third hole portion provided at another end portion of the bus bar; the lower cover may include a projecting portion that projects toward the third hole portion of the bus bar; and relative movement of the bus bar and the lower cover may be restricted with the projecting portion inserted into and engaged with the third hole portion. With this configuration, it is possible to suppress turning of the bus bar due to a fastening operation etc. when a different terminal is connected to a different end portion of the bus bar, and thus, it is possible to reduce a load on a different portion of the bus bar.

The bus bar structure according to an embodiment of the technology disclosed herein may include an upper cover provided to extend along the bus bar to cover a second surface of the bus bar opposite to the first surface of the bus bar that faces the outer surface of the housing. Providing the upper cover enables suppressing noise as well as improving insulation.

In the above bus bar structure according to an embodiment of the technology disclosed herein, the housing may be a housing of a power conversion device. There are a variety of aspects of the power conversion device, and it is advantageous that the bus bar structure can absorb variations in the points of attachment. The power conversion device may be a device configured to control electric power to be supplied to a traction motor.

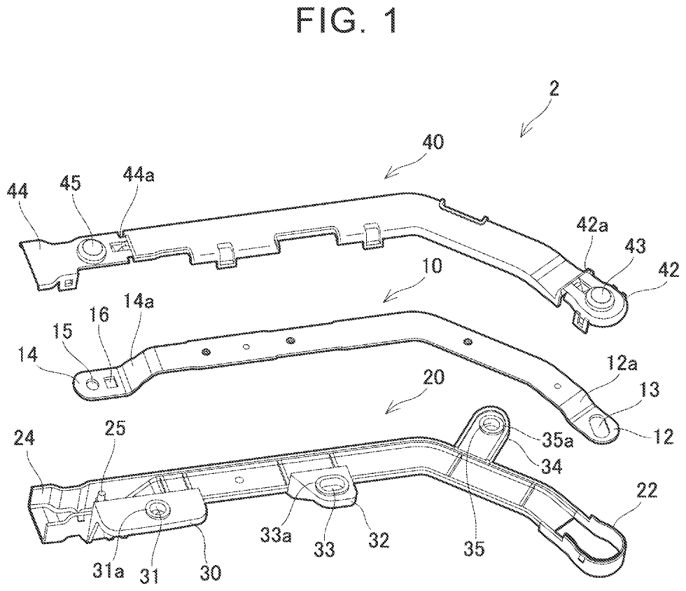

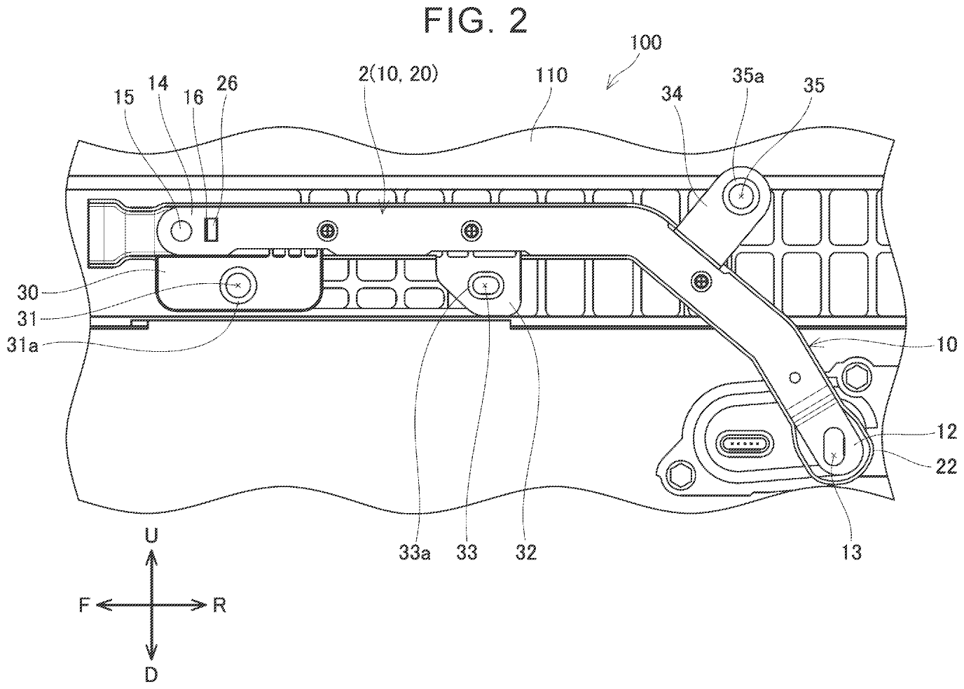

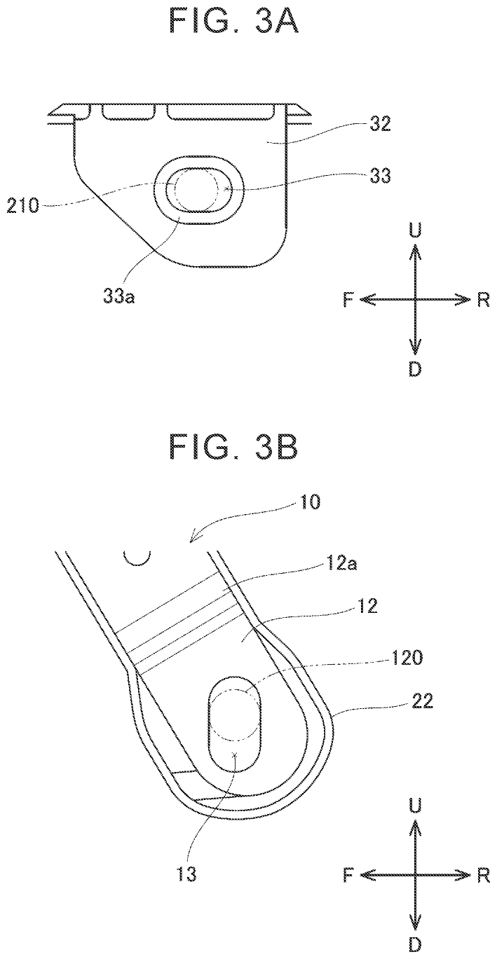

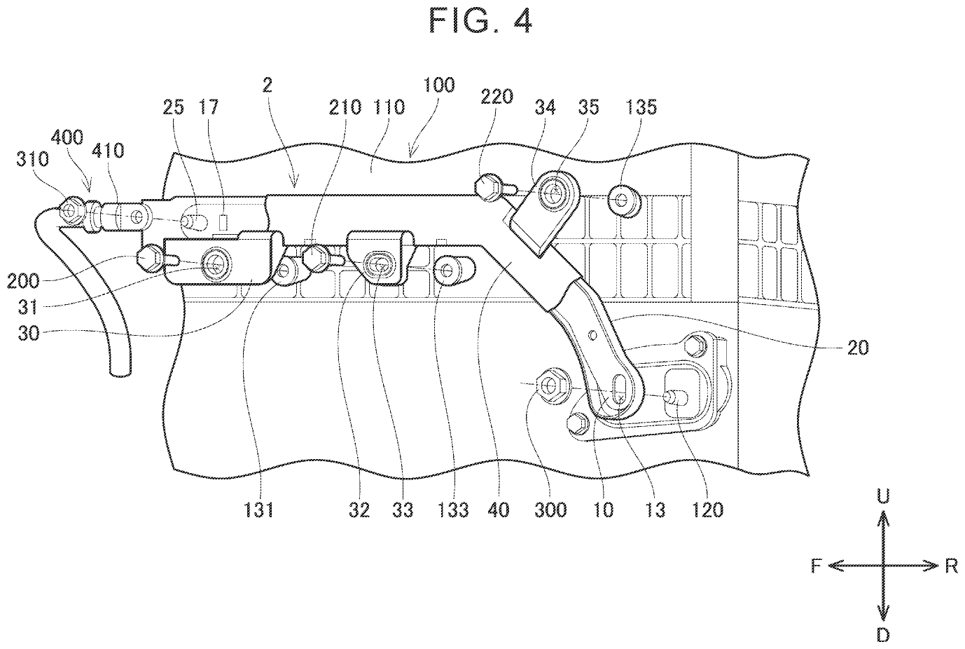

A bus bar structure 2 disclosed herein will be described below with reference to the drawings. FIG. 1 is an exploded view of the bus bar structure 2. FIG. 2 illustrates the arrangement of the bus bar structure. FIGS. 3A and 3B are each an enlarged view of a part of the bus bar structure. FIG. 4 illustrates the state of attachment of the bus bar structure to a housing. In the following description, the front side and the rear side of a vehicle in the vehicle front-rear direction are denoted by “F” and “R”, respectively, and the upper side and the lower side of the vehicle in the vehicle up-down direction are denoted by “U” and “D”, respectively. The vehicle width direction is a direction that is perpendicular to the vehicle front-rear direction and the vehicle up-down direction.

A housing is not specifically limited herein, and may be a housing that houses a power conversion device or an electrical device such as a power control unit (PCU) of the vehicle. The power control unit is an example of a power conversion device that includes an inverter, a converter, etc., and controls electric power to be supplied to a traction motor connected to wheels of the vehicle, for example.

The bus bar structure 2 is a structure that is attached to a side surface 110 of a housing 100 of the PCU of the vehicle. The bus bar structure 2 is a structure configured to attach a bus bar 10 that electrically connects a PCU-side terminal on the rear side in the vehicle front-rear direction (the rear side in the vehicle front-rear direction may be referred to as the vehicle rear side) to a wire harness terminal on the front side in the vehicle front-rear direction (the front side in the vehicle front-rear direction may be referred to as the vehicle front side), on one of side surfaces that face each other in the vehicle width direction.

As illustrated in FIG. 1, the bus bar structure 2 includes the bus bar 10, a lower cover 20, and an upper cover 40, which are assembled together to form a single structure. As illustrated in FIG. 2, the bus bar structure 2 is attached to a side surface of the housing 100 for the PCU. In FIG. 2, the upper cover 40 is not illustrated for convenience of description.

The bus bar 10 is a flat elongated conductive member made of metal (typically copper). The bus bar 10 is disposed to extend along one side surface 110 of the housing 100. The bus bar 10 extends straight toward the vehicle front side and is bent obliquely downward at the vehicle rear side as seen from a side. An end portion 12 at the vehicle rear side and an end portion 14 at the vehicle front side of the bus bar 10 each have a substantially flat shape to conform to the side surface 110 or the lower cover 20 interposed between the side surface 110 and the bus bar 10. At the same time, a middle portion of the bus bar 10 between the end portion 12 and the end portion 14 has an arch shape to be spaced from the side surface 110. The bus bar 10 includes inclined portions 12a, 14a respectively provided at a position that is in the vicinity of the end portion 12 and closer to the middle portion than the end portion 12, and at a position that is in the vicinity of the end portion 14 and closer to the middle portion than the end portion 14, to rise (i.e., to be inclined) toward the middle portion. The middle portion between the inclined portions 12a, 14a is substantially flat.

A shearing load caused by a difference in the linear expansion of a material due to high and low temperatures in the vicinity of the bus bar 10 can be reduced, in particular, with the bus bar 10 having the inclined portions 12a, 14a. The bus bar 10 includes a hole portion 13 provided at the end portion 12, and hole portions 15, 16 provided at the end portion 14. The hole portions 13, 15, 16 will be discussed later.

The lower cover 20 is made of an insulating material such as resin, and insulates the side surface 110-side of the bus bar 10 (i.e., a surface of the bus bar 10, which faces the side surface 110). The lower cover 20 extends along the direction of extension of the bus bar 10, and has a substantially recessed sectional shape so as to house the bus bar 10 by covering the side surface 110-side and the upper and lower sides of the bus bar 10. An end portion 22 of the lower cover 20 at the vehicle rear side has an outer frame shape to open so as to expose the end portion 12 of the bus bar 10 to the side surface 110 of the housing 100. An insert bolt 25 that projects toward the bus bar 10 is attached at an end portion 24 of the lower cover 20 at the vehicle front side. The insert bolt 25 is a bolt to be inserted through a hole portion of a terminal 410 of a vehicle wire harness 400 and the hole portion 15 at the end portion 14 of the bus bar 10 to be attached.

The lower cover 20 includes attachment base portions 30, 32, 34 for attachment to the housing 100. The attachment base portion 30 is located at the vehicle front side, and projects toward the lower side in the vehicle up-down direction (hereinafter, the lower side in the vehicle up-down direction may be referred to as the vehicle lower side) from a side surface of the lower cover 20 at the vehicle lower side. The attachment base portion 32 is located at the substantially middle portion of the lower cover 20 in the vehicle front-rear direction, and projects toward the vehicle lower side from a side surface of the lower cover 20 at the vehicle lower side. The attachment base portion 34 is located at the vehicle rear side, and projects toward the upper side in the vehicle up-down direction (hereinafter, the upper side in the vehicle up-down direction may be referred to as the vehicle upper side) from a side surface of the lower cover 20 at the vehicle upper side. The attachment base portions 30, 32, 34 include attachment hole portions 31, 33, 35, respectively. The attachment hole portions 31, 33, 35 are provided with collars 31a, 33a, 35a, respectively, embedded therein. The attachment hole portions 31, 33, 35 will be discussed later.

The upper cover 40 also has an elongated shape extending along the bus bar 10, and is made of an insulating material such as resin. The upper cover 40 is attached to the lower cover 20 so as to cover the bus bar 10. A plurality of lugs (not illustrated) is provided at the edge of the lower cover 20. A plurality of retention holes (not illustrated) is provided at the edge of the upper cover 40 so as to face the corresponding lugs. When the upper cover 40 is attached to the lower cover 20, the lugs are respectively retained in the retention holes so that the upper cover 40 is fixed with respect to the lower cover 20.

An end portion 42 of the upper cover 40 at the vehicle rear side and an end portion 44 of the upper cover 40 at the vehicle front side are provided with portions 42a, 44a that are proximate to the end portions 42, 44 and that are bendable to open and close the end portions 42, 44, respectively. The end portions 12, 14 of the bus bar 10 are exposed when the end portions 42, 44 are opened. Therefore, it is possible to connect the end portions 12, 14 of the bus bar 10 and the PCU-side terminal and the terminal 410 of the wire harness 400 while maintaining the integrity of the bus bar structure 2.

Projected portions 43, 45 are provided at the end portions 42, 44, respectively, of the upper cover 40. The projected portions 43, 45 are hollow inside, and can house nuts 300, 310 that fix an insert bolt 120 that projects from the housing 100 and the insert bolt 25 that projects from the lower cover 20, respectively (see FIG. 4).

Next, the hole portions 13, 15, 16 provided at the end portions 12, 14 of the bus bar 10 and the attachment hole portions 31, 33, and 35 of the lower cover 20 will be described. First, the attachment hole portions 31, 35 of the lower cover 20 are described. As illustrated in FIGS. 1, 2, and 4, the attachment hole portions 31, 35 are provided as circular hole portions with the collars 31a, 35a, respectively, provided therein. As is well illustrated in FIG. 4, the attachment hole portions 31, 35 are respectively provided to enable predetermined bolts 200, 220 to be screwed into female thread portions 131, 135 provided at predetermined positions on the side surface 110 of the housing 100 (see FIG. 4).

As illustrated as enlarged in FIG. 3A, the attachment hole portion 33 is provided as a long hole portion including the collar 33a provided therein and having a major axis extending in the vehicle front-rear direction. As illustrated in FIG. 4, the attachment hole portion 33 is provided to enable a predetermined bolt 210 to be screwed into a female thread portion 133 provided in the side surface 110 of the housing 100. The attachment hole portion 33 is an example of a first hole portion according to the disclosure. The position of the female thread portion 133 is an example of a first position on the housing. The bolt 210 screwed into the female thread portion 133 is an example of a fixing member according to the disclosure.

The attachment hole portion 33 that is a long hole has such a size that the minor axis (dimension in the vehicle up-down direction) of the attachment hole portion 33 substantially coincides with the outside diameter of a shaft body of the bolt 210 that is used for attachment to the housing 100 and the outer periphery of the shaft body of the bolt 210 contacts the inside surfaces defining the attachment hole portion 33, the inside surfaces defining the attachment hole portion 33 facing each other in the minor-axis direction. Consequently, it is possible to position the lower cover 20 and the bus bar structure 2 in the up-down direction.

Since the attachment hole portion 33 is a long hole, the seating surface (i.e., bearing surface) of a head portion of the bolt 210 contacts the peripheral edge of the attachment hole portion 33, including the collar 33a, over a sufficient contact area when the bolt 210 is fastened. That is, a contact area is secured in the direction along the minor-axis direction of the attachment hole portion 33. Consequently, buckling of the fastening seating surface is avoided.

As illustrated in FIGS. 1, 2, and 4, the hole portion 13 provided at the end portion 12 of the bus bar 10 at the vehicle rear side is a hole portion for connecting the bus bar 10 to the PCU-side terminal. As illustrated in FIG. 4, the hole portion 13 allows insertion of the insert bolt 120 that is electrically connected to a terminal of the PCU in the housing 100. Further, the nut 300 can be fastened to the insert bolt 120 that further projects toward the upper cover 40 through the hole portion 13.

As illustrated as enlarged in FIG. 3B, the hole portion 13 is provided as a long hole portion having a major axis extending in the vehicle up-down direction. The hole portion 13 has such a size that the minor axis (dimension in the vehicle front-rear direction) of the hole portion 13 substantially coincides with the outside diameter of a shaft body of the insert bolt 120 that is used for attachment to the housing 100 and the outer periphery of the shaft body of the insert bolt 120 contacts the inside surfaces defining the hole portion 13, the inside surfaces defining the hole portion 13 facing each other in the minor-axis direction. Consequently, it is possible to position the bus bar 10 and the bus bar structure 2 in the right-left direction. The hole portion 13 is an example of a second hole portion according to the disclosure. The position of the insert bolt 120 is an example of a second position on the housing. The insert bolt 120 is an example of a connection member according to the disclosure.

Since the hole portion 13 is a long hole, the seating surface of the nut 300 contacts the peripheral edge of the hole portion 13 over a sufficient contact area when the nut 300 is fastened. That is, a contact area is secured in the direction along the minor-axis direction of the hole portion 13. Consequently, buckling of the fastening seating surface is avoided.

As illustrated in FIGS. 1, 2, and 4, the hole portion 15 is provided at the end portion 14 of the bus bar 10 at the vehicle front side to enable insertion of the shaft body of the insert bolt 25 that projects toward the bus bar 10 from the lower cover 20. As illustrated in detail in FIG. 4, the insert bolt 25 that projects toward the upper cover 40 from the hole portion 15 is inserted through the terminal 410 of the wire harness 400 to be fastened by the nut 310.

The hole portion 16 provided at the end portion 14 has a rectangular shape to extend in the up-down direction. The hole portion 16 is engageable with a projecting portion 26 provided at the end portion 24 of the lower cover 20 and having a rectangular cross section in the bus bar structure 2. The bus bar 10 is restrained from rotating with respect to the lower cover 20 with the projecting portion 26 and the hole portion 16 engaged with each other.

The bus bar structure 2 includes the insert bolt 25 that projects from the lower cover 20 to be inserted into the hole portion 15 of the bus bar 10, and is fixed at a predetermined position by fixing units such as screws via a plurality of hole portions arranged in the direction of extension of the bus bar 10. Further, the upper cover 40 is retained on the lower cover 20 so as to cover the bus bar 10, and thus, the bus bar structure 2 is provided as an integrated assembly.

Next, a method of disposing the bus bar structure 2 on a side surface of the housing 100 so as to be able to energize the PCU-side terminal and the wire harness-side terminal will be described with reference to FIGS. 2 and 4. It is assumed that the housing 100 is disposed with the depth direction, the height direction, and the width direction of the housing 100 coinciding with the vehicle front-rear direction, the vehicle up-down direction, and the vehicle width direction, respectively.

The bus bar structure 2 is disposed at a predetermined position on the side surface 110 of the housing 100. The side surface 110 extends along the vehicle front-rear direction. Consequently, the attachment hole portion 33 at the attachment base portion 32 of the lower cover 20 is appropriately disposed with respect to the female thread portion 133. Further, when the bolt 210 is inserted into the female thread portion 133 via the attachment hole portion 33, the upper and lower sides of the shaft body of the bolt 210 contact the inner peripheral surfaces defining the attachment hole portion 33, the peripheral surfaces defining the attachment hole portion 33 facing each other in the minor-axis direction. Consequently, positioning of the bus bar structure 2 in the vehicle up-down direction is achieved. At this time, the insert bolt 120 that is joined to the PCU-side terminal and projects toward the bus bar 10 penetrates the hole portion 13 provided at the end portion 12 of the bus bar 10. The hole portion 13 has a major axis extending in the vehicle up-down direction, and the insert bolt 120 contacts the inner peripheral surfaces defining the hole portion 13, the inner peripheral surfaces defining the hole portion 13 facing each other in the minor-axis direction. Therefore, positioning of the bus bar structure 2 in the right-left direction is achieved.

In this manner, the attachment hole portion 33 and the hole portion 13 can contribute to positioning in the vehicle up-down direction and the vehicle front-rear direction. Therefore, it is possible to secure the precision in attaching the bus bar structure 2 to the housing 100, although the attachment hole portion 33 and the hole portion 13 are long holes. In addition, it is possible to secure a sufficient contact area when a bolt and a nut are subsequently fastened, since each of the attachment hole portion 33 and the hole portion 13 is a long hole. Consequently, bucking of the fastening seating surface is effectively suppressed or avoided.

In this state, the bolt 210 is screwed into the female thread portion 133 via the attachment hole portion 33 to be fastened. Then, the bolts 220, 200 are respectively screwed into the female thread portions 135, 131 of the housing 100 via the attachment hole portions 35, 31 to be fastened, in the order of the attachment base portion 34 and the attachment base portion 30.

Further, the end portion 42 of the upper cover 40 is opened to expose the end portion 12 of the bus bar 10 in the end portion 22 of the lower cover 20. The nut 300 is screwed onto and fastened to the insert bolt 120 that is inserted into the hole portion 13 provided at the end portion 12 to be projected. When the insert bolt 120 and the nut 300 are fastened at the hole portion 13, the end portion 42 of the upper cover 40 is closed so that the nut 300 is housed in the projected portion 43.

After the lower cover 20 is attached to the housing 100 using the attachment hole portion 33 in this manner, the bus bar 10 is connected (attached) to the terminal on the housing 100 via the hole portion 13. Consequently, it is possible to attach the bus bar 10 to the terminal with the bus bar 10 stably supported by the lower cover 20, thereby improving working efficiency and securing attachment precision. When the bus bar structure 2 is attached to the side surface 110 of the housing 100, in particular, it is possible to improve the attachment precision of the bus bar structure 2, and easily avoid buckling, by positioning the bus bar structure 2 in the vehicle up-down direction using the attachment hole portion 33.

Then, the end portion 44 of the upper cover 40 is opened to expose the end portion 14 of the bus bar 10. The terminal 410 of the wire harness 400 is engaged with the insert bolt 25 that projects from the hole portion 15, and the nut 310 is screwed onto the insert bolt 25 to be fastened. The end portion 44 of the upper cover 40 is closed so that the nut 310 is housed in the projected portion 45.

In the bus bar structure 2 described above, the lower cover 20 includes the attachment hole portion 33 that is a long hole, and the bus bar 10 includes the hole portion 13 that is a long hole. Thus, the bus bar structure is adaptable to changes in the point of attachment, such as the point of connection of the bus bar to the housing 100 and the point of fixation of the lower cover to the housing 100, without requiring changes in the shapes of the bus bar 10, the lower cover 20, and the upper cover 40. The bus bar structure 2 excels in the assembly working efficiency and the assembly precision, besides the cost.

In the above embodiment, the bus bar structure 2 is on the side surface 110 of the housing 100, the side surface 110 extending along the vehicle front-rear direction. When the bus bar structure 2 is disposed on the side surface 110, there is a possibility of displacement in the up-down direction due to the gravity. With the bus bar structure 2, however, such a possibility is reduced because positioning in the up-down direction is achieved using the attachment hole portion 33. The surface of the housing 100 to which the bus bar structure 2 is attached is not limited to the side surface 110, and may be an upper surface, a different side surface, or a bottom surface.

In the above embodiment, the attachment hole portion 33 is a long hole that has a major axis extending in the vehicle front-rear direction, and the hole portion 13 is a long hole that has a major axis extending in the vehicle up-down direction. Since the major axes of the long holes are substantially orthogonal to each other (“the major axes are substantially orthogonal to each other” means the major axes intersect each other at an angle in a range of 70° to 110°, for example, or in a range of 80° to 100°, for example, or in a range of 85° to 95°, for example, or at 90° for example), it is possible to efficiently absorb changes in the points of attachment of the bus bar 10 and the lower cover 20. Work can be performed most efficiently and positioning can be performed most easily to secure attachment precision, for example, when the attachment hole portion 33 and the hole portion 13 extend in the vehicle front-rear direction and the vehicle up-down direction, respectively. Variations in the attachment position can be absorbed when the major-axis direction of the attachment hole portion 33 and the major-axis direction of the hole portion 13 intersect each other.

In the above embodiment, the attachment hole portion 33 is provided at the middle portion of the lower cover 20 in the vehicle front-rear direction, and the hole portion 13 is provided at the end portion 12 of the bus bar 10 at the vehicle rear side. Consequently, high attachment working efficiency is obtained, and the bus bar structure 2 can be positioned precisely in the up-down direction and the right-left direction. The position of the attachment hole portion 33 may be changed as appropriate, and two or more attachment hole portions as long holes may be provided, depending on the surface shape of the housing 100.

In the above embodiment, the bus bar 10 includes the inclined portions 12a, 14a provided at positions that are in the vicinity of the end portions 12, 14, respectively, and that are closer to the middle portion than the end portions 12, 14. Therefore, a shearing load caused by a difference in the linear expansion due to cooling and heating can be reduced, which improves the durability of the bus bar 10. The inclined portions 12a, 14a are not necessarily provided, and a design change is made as appropriate in accordance with the environment of use etc. of the electrical device to be housed in the housing 100.

In the above embodiment, the hole portion 16 provided at the end portion 14 of the bus bar 10 and the projecting portion 26 provided on the lower cover 20 are engaged with each other. Thus, the bus bar 10 is restrained from being turned when the terminal 410 of the wire harness 400 is fastened and fixed by the insert bolt 25 and the nut 310. Therefore, it is possible to improve working efficiency, and suppress application of a turning load to the bus bar 10.

While the upper cover 40 is non-conductive from the viewpoint of insulation in the above embodiment, this is not limiting. For example, the upper cover 40 may be conductive, and may be grounded to the side surface 110 of the housing 100 to contribute to noise suppression.

While one end portion 14 of the bus bar 10 is connected to the terminal 410 of the wire harness 400 in the above embodiment, this is not limiting. For example, the end portion 14 may be electrically connected to a different terminal prepared inside the housing 100. A person skilled in the art could conceive of a variety of modes of connection to the terminal based on the related art or technical common knowledge.

While the bolt 210 that is inserted from the outside of the lower cover 20 to be fastened is used as a fixing member configured to fix the lower cover 20 to the housing 100 via the attachment hole portion 33 in the above embodiment, this is not limiting. For example, an insert bolt provided in advance to project from the side surface 110 of the housing 100 toward the lower cover 20 may be used as the fixing member.

While the insert bolt 120 connected to the terminal of the housing 100 is used as a connection member configured to connect the bus bar 10 to the terminal via the hole portion 13 in the above embodiment, this is not limiting. For example, the terminal may be provided with a female thread portion, and a bolt to be inserted into the female thread portion via the hole portion 13 from the outer side of the bus bar 10 to be fastened may be used as the connection member.

While a specific example of the disclosure has been described in detail above, the example is merely exemplary, and is not intended to limit the scope of the claims. The technology described in the claims includes various modifications and alterations of the specific example indicated above. The technical elements indicated herein or in the drawings have technical utility alone or in various combinations, and are not limited to the combinations described in the embodiments as originally filed. In addition, the technology indicated herein or in the drawings may achieve a plurality of objects at the same time, and has technical utility by achieving one of such objects.

1. A bus bar structure comprising:
a bus bar disposed to extend along an outer surface of a housing of an electrical device; and
a non-conductive lower cover provided to extend along the bus bar to cover a first surface of the bus bar, the first surface facing the outer surface of the housing, wherein:
the lower cover includes a first hole portion that allows insertion of a fixing member configured to fix the lower cover at a first position on the outer surface of the housing, the first hole portion having a major axis extending along a first direction of the housing; and
the bus bar includes a second hole portion that allows insertion of a connection member configured to electrically connect the bus bar to a terminal at a second position on the outer surface of the housing, the second hole portion having a major axis extending along a second direction that intersects the first direction.

2. The bus bar structure according to claim 1, wherein:
the housing has a three-dimensional shape with a height, a depth, and a width;
the first direction is one of an up-down direction extending along the height of the housing, a front-rear direction extending along the depth of the housing, and a right-left direction extending along the width of the housing; and
the second direction is a direction that is orthogonal to the first direction.

3. The bus bar structure according to claim 2, wherein:
the outer surface of the housing is a side surface of the housing;
the first direction is one of the right-left direction and the front-rear direction of the housing; and
the second direction is a direction that is orthogonal to the first direction.

4. The bus bar structure according to claim 1, wherein:
the first hole portion is configured such that an outer peripheral surface of the fixing member contacts inside surfaces defining the first hole portion, the inside surfaces defining the first hole portion facing each other in a minor-axis direction of the first hole portion; and
the second hole portion is configured such that an outer peripheral surface of the connection member contacts inside surfaces defining the second hole portion, the inside surfaces defining the second hole portion facing each other in a minor-axis direction of the second hole portion.

5. The bus bar structure according to claim 1, wherein the first hole portion is provided at a middle portion of the lower cover in a direction of extension of the lower cover, and the second hole portion is provided at one end portion of the bus bar in a direction of extension of the bus bar.

6. The bus bar structure according to claim 3, wherein:
the lower cover includes the first hole portion provided at a middle portion of the lower cover in a direction of extension of the lower cover;
the first hole portion is configured such that an outer peripheral surface of the fixing member contacts inside surfaces defining the first hole portion, the inside surfaces defining the first hole portion facing each other in a minor-axis direction of the first hole portion;
the bus bar includes the second hole portion provided at one end portion of the bus bar in a direction of extension of the bus bar; and
the second hole portion is configured such that an outer peripheral surface of the connection member contacts inside surfaces defining the second hole portion, the inside surfaces defining the second hole portion facing each other in a minor-axis direction of the second hole portion.

7. The bus bar structure according to claim 1, wherein the bus bar includes inclined portions inclined from one end portion and another end portion of the bus bar in a direction of extension of the bus bar toward a middle portion of the bus bar between the one end portion and the other end portion such that the middle portion is spaced from the outer surface of the housing.

8. The bus bar structure according to claim 1, wherein:
the bus bar includes the second hole portion provided at one end portion of the bus bar in a direction of extension of the bus bar, and a third hole portion provided at another end portion of the bus bar;
the lower cover includes a projecting portion that projects toward the third hole portion of the bus bar; and
relative movement of the bus bar and the lower cover is restricted with the projecting portion inserted into and engaged with the third hole portion.

9. The bus bar structure according to claim 1, further comprising an upper cover provided to extend along the bus bar to cover a second surface of the bus bar opposite to the first surface of the bus bar that faces the outer surface of the housing.

10. The bus bar structure according to claim 1, wherein the housing is a housing of a power conversion device.

11. The bus bar structure according to claim 10, wherein the power conversion device is a device configured to control electric power to be supplied to a traction motor.

12. A method of using a bus bar structure for a housing of an electrical device, wherein the bus bar structure includes a bus bar disposed to extend along an outer surface of the housing of the electrical device, and a non-conductive lower cover provided to extend along the bus bar to cover a first surface of the bus bar, the first surface facing the outer surface of the housing, the lower cover includes a first hole portion that allows insertion of a fixing member configured to fix the lower cover at a first position on the outer surface of the housing, the first hole portion having a major axis extending along a first direction of the housing, the bus bar includes a second hole portion that allows insertion of a connection member configured to electrically connect the bus bar to a terminal at a second position on the outer surface of the housing, the second hole portion having a major axis extending along a second direction that intersects the first direction, the method comprising:
preparing the bus bar structure;
attaching the lower cover of the bus bar structure to the outer surface of the housing using the first hole portion and the fixing member; and
then connecting the bus bar of the bus bar structure to the terminal using the second hole portion and the connection member.
